(19) United States
(12) Patent Application Publication
(10) Pub. No.: US 2008/0027960 A1
(43) Pub. Date: Jan. 31, 2008

(54) Systems and methods for managing distribution lists

(75) Inventors: Chad Lewis Fulgham, Teaneck, NJ (US); Paul James Rowe, Jersey City, NJ (US); Douglas John Bayne, Glen Ridge, NJ (US); Lokesh Gupta, Powai (IN)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/495,196

(22) Filed: Jul. 28, 2006

(51) Int. Cl. G06F 7/00

(52) U.S. Cl. 707/101

(57) ABSTRACT

Email lists are managed based on the attributes of the email list members. An authorized person may generate an email list by selecting one or more attributes characterizing each member of the email list. An email list may be selected by selecting one or more attributes characterizing each member of the email list. Each email list is dynamically updated according to the attributes characterizing the email list.

### BACKGROUND OF THE INVENTION

1. Field of the Invention

The present invention relates to systems and methods for efficient communication within a large company or organization. More specifically, the invention relates to systems and methods for managing and using email distribution lists.

2. Description of the Related Art

Email provides a simple and efficient method of sending a message to another person or group within a large company or organization. An email list allows a person to send a message to a group of individuals without having to enter each person's name or address into the message's destination field. Each email list is created manually by adding individuals or groups to the new list and includes an email address of each individual in the email group. The email list is saved with an email group name. Once created and saved, the email list may be used repeatedly without having to manually add individuals.

The power to create customized email lists easily may result in a proliferation of email lists that makes selecting the proper list unmanageable. For example, it is not unrealistic to find a large organization of 20,000 employees having 20,000 email lists. Selecting the correct email list from a population of 20,000 email lists is not easy and makes the process less efficient. Furthermore, manually created email lists are static in that additions or deletions to the email list must also be done manually otherwise the static email list quickly becomes obsolete. Therefore, there remains a need for systems and methods that can generate and maintain email lists automatically.

### SUMMARY OF THE INVENTION

Email lists are generated, selected, and maintained based on the attributes of the email list members. An authorized person may generate an email list by selecting one or more attributes characterizing each member of the email list. An email list may be selected by selecting one or more attributes characterizing each member of the email list. Each email list is dynamically updated according to the attributes characterizing the email list.

One embodiment of the present invention is directed to system comprising: an authoritative data source including at least one attribute characterizing a person; a directory service storing at least one email group, the at least one email group characterized by the at least one attribute; and an aggregator configured to pull updated attribute data from the authoritative data source and update the at least one email group in the directory service with the updated attribute data. In some embodiments, the system further comprises a group database storing an email group name and one or more attributes associated with the email group; and an interface enabling a user to select an email group by selecting a value of one of the one or more attributes associated with the email group. In some further embodiments, the interface further comprises an interface to an email application, the interface providing the email application with the selected email group name.

Another embodiment of the present invention is directed to a method comprising the steps of: receiving updated attribute data from an authoritative data source; generating an updated email group from the received attribute data; transmitting the updated email group to a directory service; and storing at least one attribute characterizing the updated email group with a group name representing the updated email group in a group database. In some embodiments, the method further comprises presenting an interface to a user, the interface allowing the user to select an email group from the directory service based on one or more attributes of the email group.

Another embodiment of the present invention is directed to a method comprising the steps of: invoking an interface for selecting an email group; selecting a value of an attribute characterizing the email group; and sending a message to the selected email group.

### BRIEF DESCRIPTION OF THE DRAWINGS

The invention will be described by reference to the preferred and alternative embodiments thereof in conjunction with the drawings in which:

FIG. 1 is a block diagram illustrating an embodiment of the present invention;

FIG. 2 is a screenshot of a custom user interface used in some embodiments of the present invention;

FIG. 3 is a screenshot of another view of the custom user interface used in some embodiments of the present invention; and

FIG. 4 is a screenshot of a mail application invoked through the custom user interface of FIG. 3.

### DETAILED DESCRIPTION

The description herein should be understood to describe only one preferred embodiment of the invention. Those skilled in the art will recognize, for example, that the described embodiment is just one simplified example of the novel system and method of automatically generating and maintaining email lists. The simplified example is all that needs to be described in detail in order to enable the more general system and method that the invention comprises.

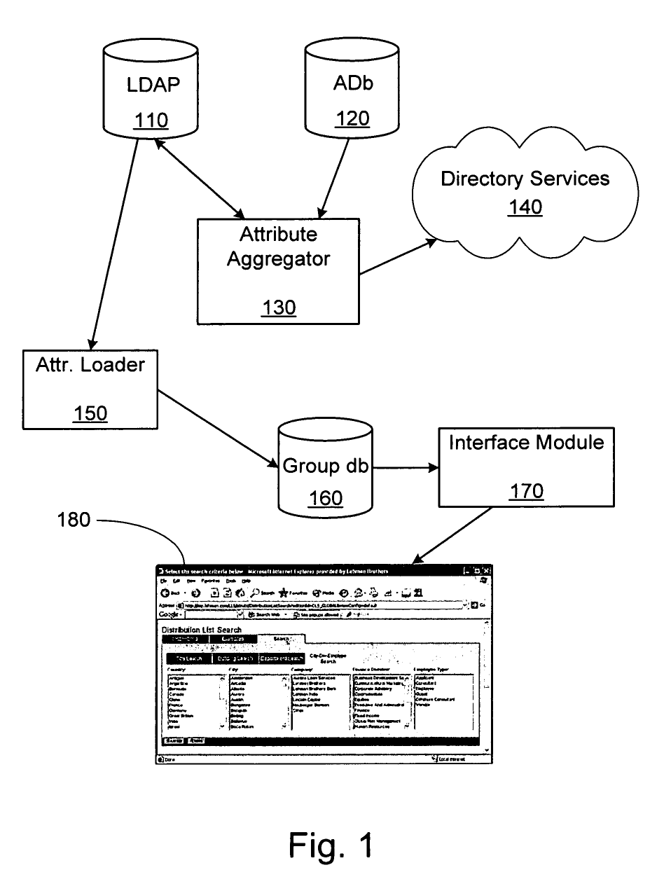

FIG. 1 is a block diagram illustrating an embodiment of the present invention. In FIG. 1, an aggregator module 130 receives attribute data from a company's authoritative data sources 110 and 120. An authoritative data source provides verified and current attribute data and may implemented, for example, using a Lightweight Data Access Protocol (LDAP) or may be implemented as an asset database (ADb) such as those described in Application Ser. No. 11/025,871 filed Dec. 29, 2004 incorporated herein in its entirety by reference.

Attribute data include an attribute type and one or more attribute values associated with the attribute type and may be any data that characterizes or is associated with an individual. Examples of such attribute data include a person's status (having values of employee, contractor, vendor, etc.), title (manager, director, etc.), location (region, city, building, floor, etc.), P&L group, and relationship to company assets such as owner or manager of a specific database or software application. The variety and number of attributes is only limited by the attributes and relationships maintained by the authoritative data sources.

The aggregator module 130 allows users to query, update, and create email groups based on the characteristics of the group. Examples of groups based on member attributes include a group of all employees of a company, a group of all managers of an Oracle database, a group of all people located in a particular building in a specified city, or a group associated with a specific project.

The aggregator module 130 is configured to automatically update an existing group when one of the authoritative data sources is updated. For example, the aggregator module may be configured to pull or query attribute information every night after ADb has performed its daily update. Alternatively, the aggregator module may be configured to receive automatically an update feed that is generated by the authoritative data source during its regular update cycle. Similarly, the attribute loader may be configured to update the group database after the aggregator module has updated the email groups in LDAP and Active Directory. The automatic update or synchronization with the authoritative data source keeps each existing group current without having to edit each member of the group individually as the member's status changes.

In some embodiments, access to the aggregator module is restricted using a delegated security model that prevents unauthorized persons from creating or modifying the groups. New groups may be created by specifying a group name and one or more attributes that characterize the group. The new group definition is loaded into the aggregator module by an authorized user. Once the group definition is loaded into the aggregator module, the new group is generated in the same manner as the pre-existing groups.

The generated email groups may be written to one or more directory services on the company's network. Examples of such services include Active Directory or an LDAP database. In the example shown in FIG. 1, the generated email groups are stored in Active Directory 140 and an LDAP database 110. In a preferred embodiment, email users may select an email group stored in Active Directory to send email messages to the group. The generated email groups are also stored in the LDAP database, which supports an interface that allows a user to select the appropriate email group stored in Active Directory.

An attribute loader 150 receives or requests group information from the LDAP database and stores the email group name and its associated attributes in a group database 160. The information stored in the group database 160 is used to populate a custom user interface 180 that allows a user to select an email group. Interface module 170 populates and presents the custom user interface and receives and handles user queries. Interface module 170 is preferably implemented using standard technologies such as, for example, Java servlets, JavaBeans, ResourceBundles, and XML with a framework such as, for example, the Struts open source framework.

The custom user interface 180 is preferably a web page that may be displayed and viewed on a company's intranet. In a preferred embodiment, the user interface may be invoked directly as a web page. In other embodiments, the user interface may be invoked from an email client application.

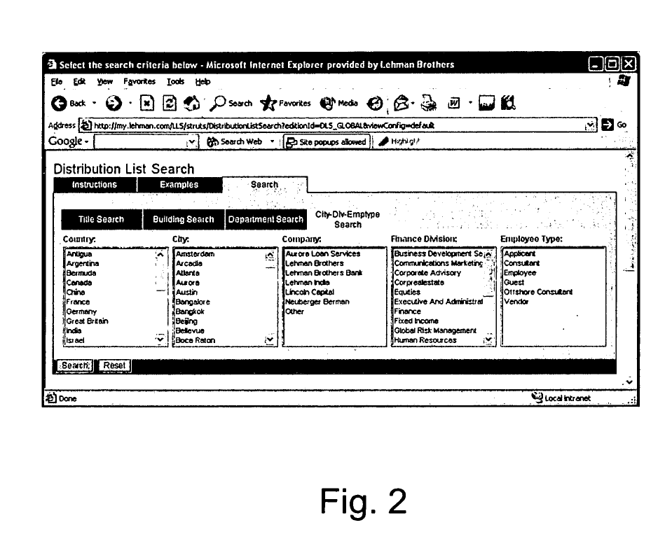

FIG. 2 is a screenshot of a user interface used in some embodiments of the present invention. In FIG. 2, the user is presented with tabs displaying one or more attributes that the user can search. In the example shown in FIG. 2, a City-Div-Emptype tab has been selected. Below the selected tab, a list box is displayed for each searchable attribute. In the example shown in FIG. 2, five list boxes are displayed for the Country, City, Company, Finance Division, and Employee Type attribute. Within each list box, a list of possible values for that attribute is shown. The user selects a value from at least one of the list boxes and clicks on the Search button. When the Search button is pressed, the interface module searches the group database for the group or groups satisfying the search criteria selected by the user.

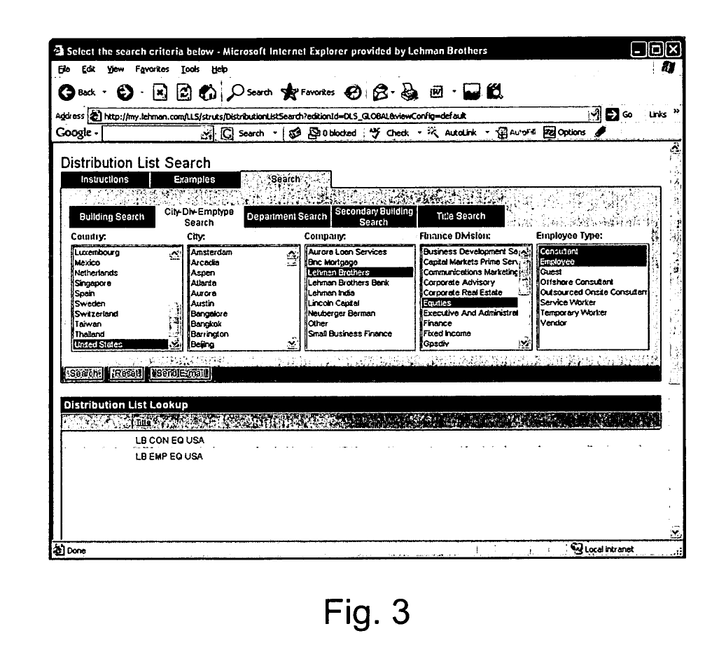

FIG. 3 is a screenshot of the user interface displaying the results of the search. In FIG. 3, a list of groups satisfying the selected search criteria are displayed in a distribution list lookup box. In the example shown in FIG. 3, two groups are returned. A Send E-mail button is displayed that allows the user to send email to the groups displayed in the distribution list lookup box.

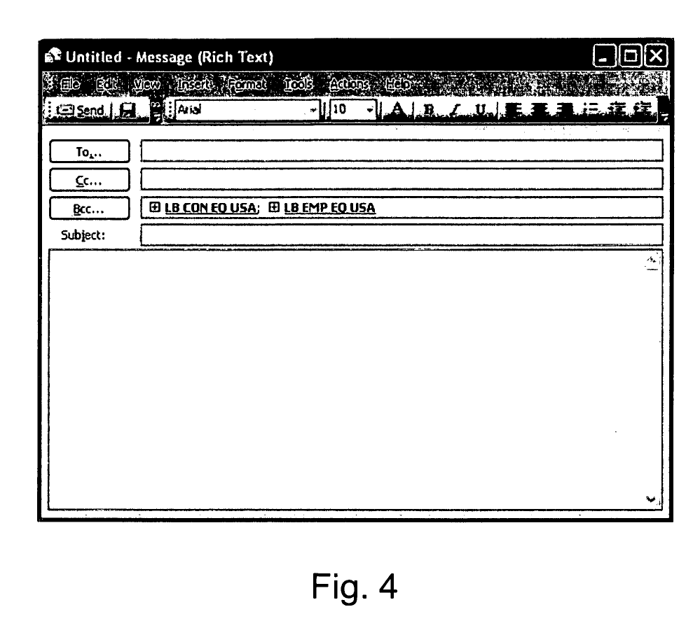

FIG. 4 is a screenshot of the user interface displaying an email client after the user has pressed the Send E-mail button. When the user presses the Send E-mail button, the interface module invokes the user's email client by, for example, issuing a “mailto:” command. The command invokes the user's email client, which displays a screen allowing the user to enter a message. The bcc field of the email message is automatically populated with the groups satisfying the selected search criteria. If the email client is Outlook, the client resolves the group names using the groups stored in Active Directory.

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed:

1. A system comprising:
an authoritative data source including at least one attribute characterizing a person;
a directory service storing at least one email group, the at least one email group characterized by the at least one attribute; and
an aggregator configured to pull updated attribute data from the authoritative data source and update the at least one email group in the directory service with the updated attribute data.

2. The system of claim 1 further comprising:
a database storing an email group name and the one or more attributes associated with the email group; and
an interface enabling a user to select an email group by selecting a value of one of the one or more attributes associated with the email group.

3. The system of claim 2 wherein the interface further comprises an interface to an email application, the interface to the email application providing the email application with the selected email group.

4. A method comprising the steps of:
receiving updated attribute data from an authoritative data source;
generating an updated email group from the attribute data;
transmitting the updated email group to a directory service; and
storing in a database at least one attribute characterizing the updated email group with a group name representing the updated email group.

5. The method of claim 4 further comprising presenting an interface to a user, the interface allowing the user to select an email group from the directory service based on one or more attributes of the email group.

6. A method comprising the steps of:
invoking an interface for selecting an email group;
selecting a value of an attribute characterizing the email group; and
sending a message to the selected email group.
